(19) United States
(12) Patent Application Publication
(10) Pub. No.: US 2015/0298258 A1
(43) Pub. Date: Oct. 22, 2015

(54) POWDER NOZZLE FOR A LASER POWDER WELDING DEVICE

(71) Applicant: SIEMENS AKTIENGESELLSCHAFT, München (DE)

(72) Inventors: Nikolai Arjakine, Berlin (DE); Bernd Burbaum, Falkensee (DE); Torsten Jokisch, Neuenhagen bei Berlin (DE); Michael Ott, Mulheim an der Ruhr (DE); Sebastian Piegert, Lubbenau (DE)

(73) Assignee: SIEMENS AKTIENGESELLSCHAFT, München (DE)

(21) Appl. No.: 14/432,569

(22) PCT Filed: Sep. 4, 2013
(86) PCT No.: PCT/EP2013/068220

§ 371 Date: Mar. 31, 2015

(30) Foreign Application Priority Data
Oct. 1, 2012 (EP) 12186764.2

(51) Int. Cl. B23K 26/34

(52) U.S. Cl. CPC B23K 26/345; B33Y 40/00

(57) ABSTRACT

A powder supply device (1) for a laser powder welding device and a laser powder welding device having such a powder supply device (1). The powder supply device (1) has a nozzle head (3) which tapers along a longitudinal axis (2) of the powder supply device (1) in the direction to a first end (4). A cavity (6) is arranged radially about the longitudinal axis (2) in an interior of the nozzle head (3) and tapers to the first end (4) of the nozzle head (3). The cavity (6) opens out into an annular opening (7) at the first end (4) for discharging a powder. The powder supply device (1) has a plurality N of powder feed lines (8-1, 8-2, 8-3) which extend through a second end (5) of the nozzle head (3), which lies opposite the first end (4) of the nozzle head, in the direction toward the cavity (6) and direct the powder from a powder reservoir into the cavity (6).

### CROSS-REFERENCE TO RELATED APPLICATIONS

The present application is a 35 U.S.C. §§371 national phase conversion of PCT/EP2013/068220, filed Sep. 4, 2013, which claims priority of European Patent Application No. 12186764.2, filed Oct. 1, 2012, the contents of which are incorporated by reference herein. The PCT International Application was published in the German language.

### TECHNICAL FIELD

The invention relates to a powder feeding device for a laser powder deposition welding device and to a laser powder deposition welding device with such a powder feeding device and also to the use thereof for adding to, building up or repairing a workpiece.

### TECHNICAL BACKGROUND

In laser powder deposition welding, a fine metallic powder is applied to a location on a workpiece and melted there by a laser and fused to the workpiece. For this purpose, usually a specified amount of powder is continuously applied and melted, with the powder feed and the laser being moved over or in relation to the workpiece. In this way, material can be added to the workpiece, so that it can be added to or repaired. For a repair, for example, a damaged location of the workpiece may be drilled out and the drilled-out location may then be subsequently filled in the course of the laser powder deposition welding. Step-by-step building up of a workpiece can also be performed in this way. Such methods are of special importance in particular in cases of working with large monocrystalline workpieces, such as for example in the production or so-called refurbishment of gas turbines.

In such methods, the selection of suitable parameters for the amount of powder to be fed, the power of the laser, the diameter of the laser and the relative speed at which the powder feed and the laser are passed over the workpiece have a great influence on the properties of the process. For results that are good, and especially reproducible, an exact setting and maintenance of the chosen parameters is of great importance. It is therefore desirable, inter alia, to be able to keep the amount of powder that is fed within a specified time period as constant as possible, so that constant properties can be ensured during the melting by the laser. For example, the power of the laser may be set such that the specified amount of powder is completely melted, so that no crystal nuclei remain in the melt, but without allowing any appreciable vaporization of the melted powder to occur as a result of a laser power that is too high. If the amount of powder were to vary too much here, either too much material of the workpiece may be melted or vaporizes, or else the powder applied cannot be melted completely, so that disturbing crystal nuclei remain in the partial melt, disturbing an epitaxial continuation of the crystal structure of the underlying workpiece.

The conventional nozzle systems that are usually used for feeding the powder into the laser melt are intended for use within wide laser power ranges of approximately 100 W to several kilowatts. Furthermore, these nozzle systems are intended for diverse applications, for example coating applications, materials or combinations of materials. In applications that are at the forefront here, relating to a process known as micro-cladding, relatively low powder feeding rates of approximately 100 to 400 milligrams per minute, a relatively small powder focus of 600 micrometers and less are required in the zone of interaction of the laser radiation, the powder material and the base material. The powder materials used in these cases are used in a limited grain fraction of 25 to 50 micrometers in diameter. The powder particles should in this case be formed as spherically as possible. Departing too far from these specifications, for example because there are too many nonspherical grains or grains with a diameter smaller than 20 micrometers are contained, may have the effect of impairing the transportability of the powder in the powder nozzle

causing the powder nozzle to become blocked. The invention therefore introduces a powder feeding device that is specifically designed for the requirements of the micro-cladding process.

### SUMMARY OF THE INVENTION

A first aspect of the invention therefore discloses a powder feeding device for a laser powder deposition welding device. The powder feeding device has a nozzle head, which tapers along a longitudinal axis of the powder feeding device to a first end and which has a cavity. The cavity is arranged radially around the longitudinal axis in an interior of the nozzle head and tapers to the first usually bottom end of the nozzle head. The cavity opens out into an annular opening, arranged at the first end, for discharging a powder. The powder feeding device has a plurality N of powder feeding pipelines, which extend through a second end of the nozzle head, opposite from the first end of the nozzle head, past a transition and to the cavity and are designed to direct the powder from a powder reservoir into the cavity.

The powder feeding device of the invention offers the advantage of a particularly homogeneous powder distribution in the zone of interaction, in that a number of powder feeding pipelines open out into a preferably single annular cavity within the nozzle head, which in turn opens toward the workpiece being worked in an annular opening. The powder feeding device can be produced without undercuts within the nozzle head, so that accumulations of powder and blockages that would hinder the uniform transport of the powder can be avoided. The powder feeding device may also be used tiltably, whereby 3D or 360°-orbital working becomes possible, which is advantageous in particular in the case of irregularly formed workpieces.

Embodiments of the powder feeding device according to the invention allow the use of powder with a smaller grain fraction, of for example 5 to 20 micrometers in diameter, and also of powders with a greater small fraction, for example with a fraction of up to 5 percent of grains with a diameter of less than 20 micrometers, without agglomerations occurring within the powder feeding device. As a result, the effort involved in screening the powder to improve the transportability of the powder can be reduced, which makes it possible for the micro-cladding process to be carried out at lower cost. The use of finer powders (grain fraction of 5 to 20 micrometers in diameter) can also open up new applications for the micro-cladding process. Lower or higher application rates are conceivable here in particular. Other alloys and combinations of alloys may also be weldable.

Each powder feeding pipeline is preferably arranged at an equal distance from the powder feeding pipelines neighboring it on both sides. This ensures that the same amount of powder per unit of time is fed along the circumference of the annular opening, which brings about a particularly uniform feeding and distribution of the powder in the cavity and in the zone of interaction. In all of the embodiments of the powder feeding device according to the invention, each powder feeding pipeline has the same diameter.

Each powder feeding pipeline may be designed to direct the powder into the cavity along a transporting direction. In this case, a main directional component of the transporting direction is preferably aligned parallel to the longitudinal axis of the powder feeding device. This means that, in relation to the longitudinal axis of the powder feeding device, the powder in the powder feeding pipelines undergoes a smaller movement perpendicularly to the longitudinal axis than parallel to the longitudinal axis. This causes lowest possible transporting resistance of the powder feeding pipelines to the powder being transported. A high feeding resistance would promote buildups of the powder, and consequently accumulations of powder and blockages.

In this case, an angle between the transporting direction and the longitudinal axis may with particular preference be at most 20 degrees. As a result, the powder is brought up to the cavity in the nozzle head slowly, over a relatively long distance.

A distance between any one of the powder feed pipelines and the longitudinal axis preferably decreases from the second end of the nozzle head in the direction of the first end of the nozzle head.

The plurality N of powder feeding pipelines is preferably at least three. A greater number of powder feeding pipelines makes the production of such a powder feeding device more difficult, but leads to a more uniform distribution of the powder along the circumference of the annular opening. The use of only one or two powder feeding pipelines has proven to be disadvantageous, since in this case the powder is only distributed poorly.

It is preferable that the annular opening has a diameter of 1.5 millimeters or less. This relatively small diameter causes precise placement of the powder in the zone of interaction and a powder focus that is particularly suitable for the micro-cladding process. Furthermore, the powder feeding device according to the invention can be constructed in a particularly compact or smaller form if the diameter of the annular opening is chosen to be small.

The cavity may have an outer surface and an inner surface, which are respectively formed at least approximately frustoconically. As a result, the cavity itself is given a conical form, which makes improved focusing of the powder possible.

A cross-sectional area of the cavity perpendicular to the longitudinal axis preferably decreases toward the first end of the powder feeding device, whereby a focusing of the powder is achieved.

With particular preference, the nozzle head is formed rotationally symmetrically, which leads to a particularly uniform distribution of the powder. The powder feeding pipelines are then preferably arranged around the longitudinal axis at angular intervals of 360 degrees divided by the plurality N; accordingly, in the case of N=3, the angular interval respectively between two neighboring powder feeding pipelines is preferably 120 degrees.

The nozzle head may have along the longitudinal axis a through-bore that is separate from the cavity. The through-bore may have an opening at the first end of the nozzle head. The through-bore offers the advantage that the laser used in the course of the micro-cladding process for melting the powder can be directed through the powder feeding device onto the workpiece, so that access to the zone of interaction is not impeded by the powder feeding device. An alignment of the laser beam parallel to the longitudinal axis of the powder feeding device also becomes possible, whereby a uniform distribution of the power of the laser over the cross-sectional area of the zone of interaction is achieved, which leads to more uniform results.

The opening of the through-bore preferably has a diameter of 1 millimeter or less (and smaller than the diameter of the annular opening of the cavity). Generally, the diameter of the through-bore should be greater by as little as possible than the diameter of the laser, since an increase in the diameter of the through-bore beyond the amount that is minimally necessary leads to placement of the powder at an increasing distance from the center of the laser beam. Furthermore, the powder feeding device according to the invention can be constructed in a particularly compact or smaller form if the diameter of the through-bore is chosen to be small.

A second aspect of the invention introduces a laser powder deposition welding device. The laser powder deposition welding device has a powder reservoir for a powder, a powder feeding device with powder feeding pipelines, which are connected to the powder reservoir, and a laser, which is designed to melt an amount of the powder applied by the powder feeding device to a workpiece. The powder feeding device is in this case designed according to the first aspect of the invention.

A further aspect of the invention concerns the use of such a laser powder deposition welding device for adding to, building up or repairing a workpiece, preferably a gas turbine component.

### BRIEF DESCRIPTION OF THE FIGURES

The invention is described more specifically below on the basis of figures of an exemplary embodiment, in which:

FIG. 1 shows a powder feeding device according to the invention for a laser powder deposition welding device in longitudinal section; and

FIGS. 2, 3 and 4 respectively show a cross-sectional drawing through the powder feeding device along the cross-sectional lines II, III and IV of FIG. 1.

### DESCRIPTION OF AN EMBODIMENT

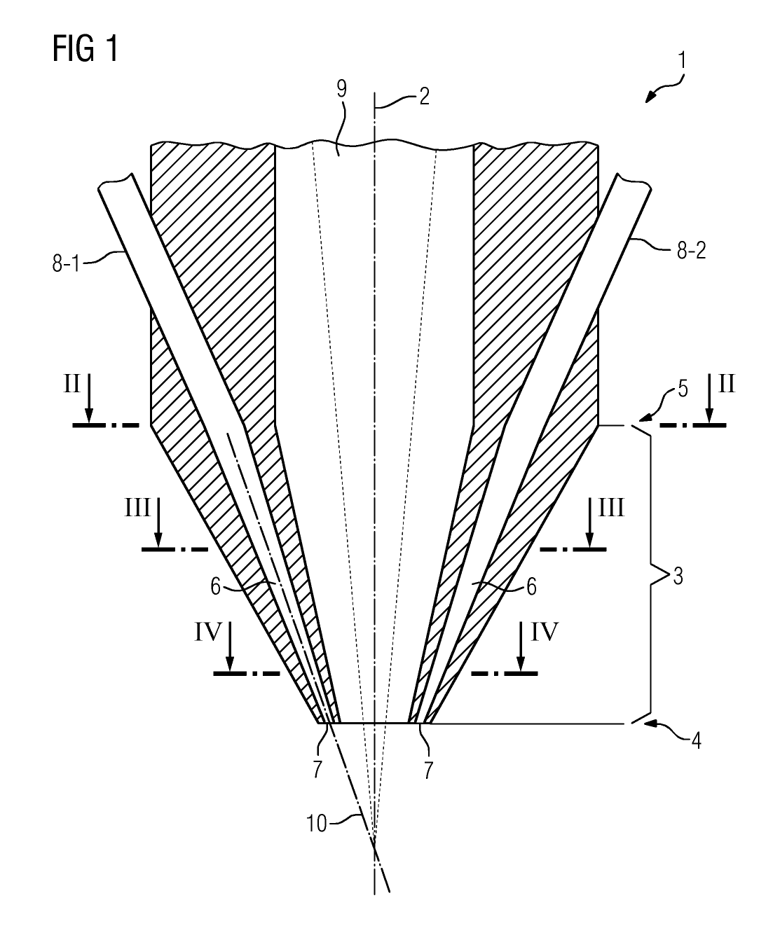

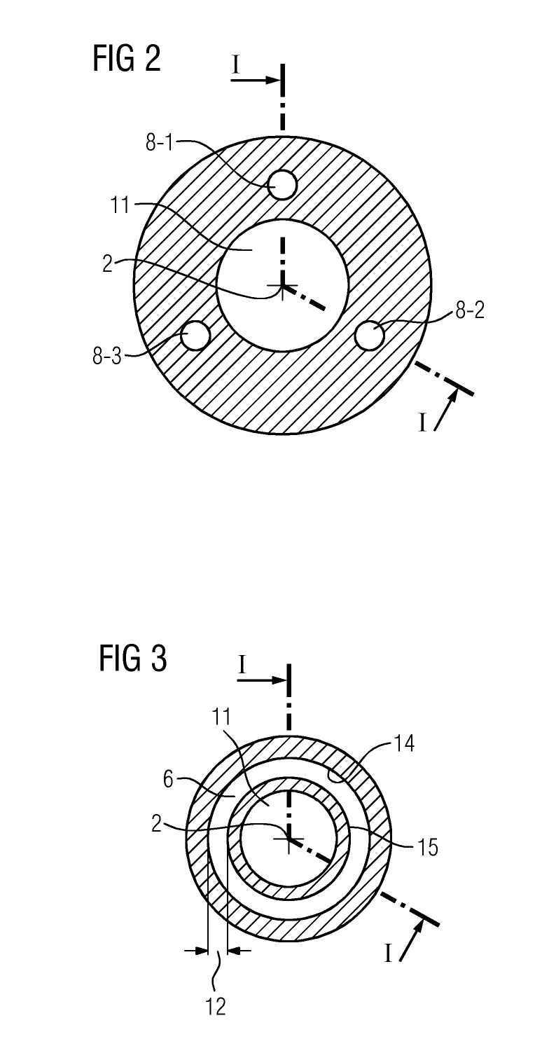

FIG. 1 shows a powder feeding device 1 according to the invention for a laser powder deposition welding device in longitudinal section. The powder feeding device 1 of the exemplary embodiment of FIG. 1 is constructed rotationally symmetrically about a longitudinal axis 2. It has a nozzle head 3. A cavity 6 is arranged in the interior of the nozzle head 3. A first end 4 of the nozzle head 3 opens out into an annular opening 7. Powder feeding pipelines 8-1 and 8-2 connect a powder reservoir (not shown) to the preferably uniform, annular conical cavity 6 and direct powder stored in the powder reservoir to the cavity 6. Powder passes from the individual powder feeding pipelines 8 into the continuously annular cavity 6 through a second end 5 of the cavity, opposite from the first end 4, into the nozzle head 3. A powder feeding pipeline 8-3 is not shown in FIG. 1. The exact spatial position of the powder feeding pipelines 8-1, 8-2 and 8-3 is shown more clearly in FIG. 2 as one example of a feeding pipeline arrangement.

In advantageous embodiments of the invention, the transition between the three separated powder feeding pipelines and the annular cavity is preferably configured linearly, so that the transition does not cause the powder that is fed by the powder feeding pipelines to clump together at the transition, e.g. at 5. The cavity 6 of the exemplary embodiment of FIG. 1 is conical, that is, it has the form of a frustum of a hollow cone. The diameter of the frustum of a hollow cone decreases toward the first end 4. The powder feeding pipelines 8-1, 8-2, 8-3 direct the powder along a respective transport direction 10, which in FIG. 1 is only shown for the powder feeding pipeline 8-1. The angle between the transporting direction 10 and the longitudinal axis 2 of the powder feeding device 1 is preferably 20 degrees or less.

Along the longitudinal axis 2, the exemplary embodiment of the powder feeding device 1 has a through-bore 11, through which a laser beam 9 can optionally be focused through the powder feeding device 1 onto the powder emerging through the annular opening 7, in order to melt the powder in the course of a micro-cladding process.

In FIG. 1, three sectional planes II, III and IV are depicted, indicating the locations of the cross sections through the powder feeding device 1 that are shown in FIGS. 2, 3 and 4, wherein the sectional plane II is assigned to

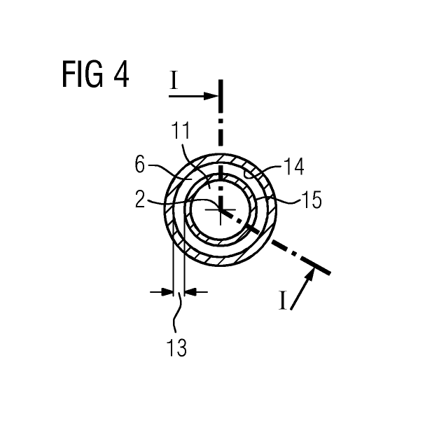

FIG. 2, the sectional plane III is assigned to FIG. 3 and the sectional plane IV is assigned to FIG. 4. In FIGS. 2, 3 and 4. A sectional area I along which the longitudinal section of FIG. 1 extends is depicted.

The sectional plane II of FIG. 2 lies approximately at the height of the second end 5 of the nozzle head 3 of the powder feeding device 1 and at the transition between the pipelines and the cavity. The through-bore 11 is at the middle of the cross section. In the interior of the nozzle head, the powder feeding pipelines 8-1, 8-2 and 8-3 are arranged spaced equally apart from one another. Measured from the longitudinal axis 2, the angle respectively between two neighboring powder feeding pipelines 8-1, 8-2, 8-3 is 120 degrees.

The sectional plane III of FIG. 3 lies between the first end 4 and the second end 5 of the nozzle head 3 and extends through the cavity 6, which is here past the transition at 5, so the cavity here has an annular cross-sectional area. An outer surface 14 of the cavity 6 is at a first distance 12 from an inner surface 15 of the cavity 6. In the example shown, the cross-sectional area of the through-bore 11 in the sectional plane III is smaller than that area in the sectional plane II. However, the through-bore 11 may also have a constant cross-sectional area over its length.

The sectional plane IV of FIG. 4 intersects the nozzle head 3 near its first end 4. In the example, a second distance 13, between the outer surface 14 and the inner surface 15 of the cavity 6 is smaller than the first distance 12 in FIG. 3. However, it is also possible to keep the diameter of the cavity 6 constant. Since the nozzle head 3 tapers toward its first end 4, and with it the cavity 6 tapers, the cross-sectional area of the cavity is likewise reduced, whereby the powder fed through the powder feeding pipelines 8-1, 8-2, 8-3 is distributed over the entire cross-sectional area of the cavity 6. Choosing the angle between the transporting direction 10 and the longitudinal axis 2 to be small has the effect of increasing the distance between the mouth of the powder feeding pipelines 8-1, 8-2, 8-3, which promotes a good distribution of the powder over the cross-sectional area of the cavity 6.

Although the invention has been more specifically illustrated and described in detail by exemplary embodiments of preferred embodiments, the invention is not restricted by the examples disclosed. Variations of the invention can be derived by a person skilled in the art from the exemplary embodiments shown without departing from the scope of protection of the invention as it is defined in the claims.

1-14. (canceled)

15. A powder feeding device for a laser powder deposition welding device, the feeding device comprising:
a nozzle head, which tapers along a longitudinal axis of the powder feeding device to a first end;
a cavity which is arranged radially around the longitudinal axis in an interior of the nozzle head, the cavity tapers to the first end of the nozzle head and opens out into an annular opening at the first end;
the nozzle head having a second end, which is opposite from the first end of the nozzle head at the first end, for discharging a powder that has been fed;
the powder feeding device comprises a plurality N of powder feeding pipelines, which extend through the second end of the nozzle head to the cavity, and each of the pipelines is configured to direct the powder along a powder transporting direction from a powder reservoir into the cavity; and
wherein a main directional component of the transporting direction is aligned parallel to the longitudinal axis of the powder feeding device.

16. The powder feeding device of claim 15, in which each powder feeding pipeline is arranged at an equal distance from the neighboring powder feeding pipelines on both sides thereof.

17. The powder feeding device of claim 16, further comprising an angle between the transporting direction and the longitudinal axis is at most 20°.

18. The powder feeding device of claim 15, wherein there is a distance between at least one of the powder feeding pipelines and the longitudinal axis which decreases from the second end of the nozzle head in the direction of the first end of the nozzle head.

19. The powder feeding device of claim 15, wherein the plurality N is at least three.

20. The powder feeding device of claim 15, wherein the annular opening has a diameter of at most 1.5 millimeters.

21. The powder feeding device of claim 15, further comprising the cavity is annular and is defined between an outer surface and an inner surface, which are respectively formed at least approximately frustoconically.

22. The powder feeding device of claim 15, wherein a cross-sectional area of the cavity perpendicular to the longitudinal axis decreases toward the first end of the powder feeding device.

23. The powder feeding device of claim 15, wherein the nozzle head is formed rotationally symmetrically.

24. The powder feeding device of claim 15, further comprising along the longitudinal axis, the nozzle head has a through-bore that is separate from the cavity and the through-bore has an opening at the first end of the nozzle head.

25. The powder feeding device of claim 24, in which the opening of the through-bore has a diameter of at most 1 millimeter.

26. A laser powder deposition welding device with a powder reservoir for a powder, the welding device comprising:
a powder feeding device with a plurality of powder feeding pipelines which are connected to the powder reservoir; and
a laser, which is configured and operable to melt an amount of the powder which is applied by the powder feeding device to a workpiece; and
the powder feeding device as claimed in claim 15.

27. A laser powder deposition welding device as claimed in claim 26, further comprising, along the longitudinal axis, the nozzle head has a through-bore that is separate from the cavity and the through-bore has an opening at the first end of the nozzle head, wherein the bore and the laser are configured and oriented that the laser generates a beam through the through-bore.
